(19) United States
(12) Patent Application Publication
(10) Pub. No.: US 2021/0016397 A1
(43) Pub. Date: Jan. 21, 2021

(54) DEVICE FOR BRAKING AND HOLDING A MACHINING ELEMENT

(71) Applicant: WEBER SCHRAUBAUTOMATEN GMBH, Wolfratshausen (DE)

(72) Inventors: Ralf Wiethoff, Weilheim (DE); Jochen Hartmann, Bad Tölz (DE); Wolfgang Wagenstaller, Wolfratshausen (DE)

(21) Appl. No.: 16/981,535

(22) PCT Filed: Mar. 14, 2019
(86) PCT No.: PCT/EP2019/056440

§ 371 Date: Sep. 16, 2020

(30) Foreign Application Priority Data
Mar. 16, 2018 (DE) 102018106193.5

(51) Int. Cl. B23P 19/00

(52) U.S. Cl. CPC B23P 19/006; B21J 15/32; B23P 19/005

(57) ABSTRACT

The invention relates to an apparatus for braking and holding a processing element that has a head and that is automatically supplied to a tool. The apparatus has a guide channel for the processing element; and a braking element that is movably supported between a braking position and a release position and that can be at least partly introduced into the guide channel to brake and hold the processing element supplied. A part of the braking element that projects into the guide channel in the braking position and thereby narrows the guide channel has an end face that faces the guide channel and that forms a latch recess for holding the head of the processing element.

The present invention relates to an apparatus for braking and holding a processing element, e.g. a screw, a nail or a rivet, that has a head and that is automatically supplied to a tool.

Such an apparatus is generally known and is, for example, used in a screwing system having an automatic screw supply to stop a screw, e.g. supplied by means of compressed air, before it is brought into engagement with the screw tool.

In simple apparatus, the stopping of the screw supplied takes place by means of a rigid metal slider that is pushed into a guide channel to completely block it. In this respect, it is problematic that the tip of the screw can be damaged on an impact onto the metal slider. In addition, particles or chips can release from the screw or from the metal slider on the impact of the screw onto the metal slider and are subsequently transported along to the screwing point, which is in particular unwanted when increased demands are made on the cleanliness of the working conditions.

Another known apparatus therefore provides a brush having a large number of elastically deformable bristles as a braking element. The screw can hereby be gently braked.

However, at high accelerations of the apparatus, this apparatus may have the disadvantage that the screw is not sufficiently fixed by the brush. High accelerations are above all to be expected when the apparatus is mounted at a robot arm and moves fast and/or upside down in operation. In these applications, there is the risk that the holding force of the brushes is overcome and the screw unintentionally moves back against its provided transport direction into the guide channel arranged upstream.

It is an object of the present invention to overcome the previously described disadvantages of the prior art and to provide an apparatus that gently brakes the screw and in this respect ensures that the screw is held securely even at high accelerations of the apparatus.

The object is satisfied by an apparatus having the features of claim 1 and in particular in that a braking element is provided that is movably supported between a braking position and a release position, that can be at least partly introduced into the guide channel to brake and hold the processing element supplied, and that comprises a part that projects into the guide channel in the braking position and thereby narrows the guide channel. This part of the braking element that projects into the guide channel in the braking position has an end face that faces the guide channel and that forms a latch recess for holding the head of the processing element.

The head of the processing element, e.g. of the screw, is securely held in the apparatus by the latch recess without the tip or another part of the processing element corresponding to the tip being affected on the braking of the processing element. A basic idea of the invention thus comprises the processing element being braked and held, in particular solely, at the head and, for example, the tip and the shaft of a screw thereby not being loaded on the braking. In addition, the head of the processing element is fixed by means of a form fit so that the head can neither move in a transport direction of the processing element in the guide channel nor move against the transport direction of the processing element out of its fixing region. A form fit is in this respect considered as the position of two components with respect to one another in which one of the components blocks the path of the other in the direction of movement considered. In other words, the one connection partner is in the way of the other in a form-fit connection. In contrast, a form fit is not present if the connection is based solely on a frictional force.

Advantageous embodiments of the invention can be seen from the dependent claims, from the description, and from the drawings.

The apparatus is preferably configured such that it brakes the processing element solely at the head. In other words, the apparatus is designed so that the braking force transmitted from the apparatus to the processing element solely, i.e. only, acts at the head of the processing element. It is hereby, for example, prevented that a tip or a shaft of the processing element is damaged by a braking force acting on it.

In accordance with an embodiment, the braking element is configured and arranged such that it applies a clamping force directed transversely to a main direction of extent of the guide channel to the head of a held processing element in the braking position. The head of the processing element is thus not only held in a form-fitted manner in the latch recess, but is additionally clamped, for example between the latch recess and an inner side of the guide channel, and is thus held by means of a force fit. Such an apparatus is easier to design than an apparatus which holds the head of the processing element with an exact fit and it is suitable to compensate production tolerances in the diameter of the head of the processing element or even to be used for processing elements of different sizes.

The braking element and/or the inner side of the guide channel can comprise an inelastic material, i.e. a material that—in contrast to brushes known from the prior art—is only deformed insignificantly when the processing element is held or clamped.

The shape of the end face of the braking element is advantageously adapted to the shape of the inner side of the guide channel. For example, the inner side of the guide channel can be straight and the end face of the braking element can correspondingly likewise be straight. The inner side of the guide channel can alternatively be curved so that the guide channel is consequently curved. In this case, the end face of the braking element can be curved in the same direction so that the inner side of the guide channel and the end face of the braking element form substantially parallel curves with respect to one another when the braking element is in the release position. A guide channel hereby results that substantially has a constant width, in particular a constant diameter.

The apparatus advantageously has a preloading device that preloads the braking element against a movement into the release position. In other words, the preloading device preloads the braking element in the direction of the braking position. It can thus be ensured that, on an interruption of the energy supply to the apparatus, the braking element reliably holds a processing element that is present in the holding position. In addition, no energy is consumed while the processing element is held by the braking element.

The braking element can have a run-on surface which is arranged upstream of the latch recess in a transport direction of the processing element and by which the guide channel is narrowed when the braking element is in the braking position. When the braking element is in the braking position, the run-on surface is preferably disposed at a flat angle to a central axis of the guide channel. For example, the angle can be in a range between 3° and 30°. The angle is in particular in a range between 5° and 20°.

The preload force acting on the braking element is preferably dimensioned such that a movement of the braking element in the direction of the release position up to an opening position can be brought about by an impact on and a sliding along of the head of the processing element at the run-on surface. In the opening position, it is possible for the head of the processing element to latch into the latch recess. The latching takes place in that the braking element moves back into the braking position again as soon as the head of the processing element penetrates into the latch recess.

In accordance with an embodiment, the preloading device is configured such that a first force is required to move the braking element from the braking position in the direction of the release position up to an opening position and such that a larger second force is required to move the braking element from the opening position further into the release position. The first force can be applied by a processing element, transported by means of compressed air, when said processing element slides along the run-on surface and thus pushes the braking element from the braking position into the opening position. In contrast, the second force is so large that it cannot be applied by the processing element. It is thus ensured that the processing element can indeed open the braking element up to the opening position, but no further, in particular not up to the release position.

For this purpose, the preloading device can have at least two spring elements or spring arrangements connected in series, with a movement of the braking element from the braking position into the opening position taking place against a first restoring force of a first spring element or of a first spring arrangement and a movement of the braking element from the opening position into the release position taking place against a second restoring force of a second spring element or of a second spring arrangement, and with the second restoring force being larger than the first restoring force. A plurality of spring elements that are connected in parallel with one another and that thus have a common spring constant are designated as a spring arrangement here.

The first and/or the second spring element can be configured as a compression spring, in particular as a spiral compression spring.

In accordance with a preferred embodiment, the braking element is pivotably arranged at a housing. Alternatively or additionally, the braking element can be linearly displaceably arranged at the housing.

The pivot axis of the braking element is advantageously arranged in front of the latch recess in the transport direction of the processing element. This enables a secure pivoting of the braking element in a simple manner when the processing element slides along the run-on surface.

The pivot axis is advantageously aligned transversely, in particular perpendicular, to the main direction of extent of the guide channel.

To release the processing element for further transport, a force application apparatus can be provided that is configured to adjust the braking element from the braking position into the release position. The force for adjusting the braking element can, for example, be generated by means of compressed air. Pneumatic cylinders are suitable for this purpose.

In accordance with an embodiment, the force application apparatus comprises a cylinder piston via which the restoring force of at least one spring element can be transmitted to the braking element and which thus represents a part of the preloading device. Consequently, the cylinder piston satisfies a dual function: it transmits the restoring force that holds the braking element in the braking position and it transmits the force that moves the braking element against the restoring force from the braking position into the release position.

The cylinder piston preferably comprises a cylinder piston attachment. The cylinder piston and the cylinder piston attachment are advantageously provided with corresponding threads so that the cylinder piston and the cylinder piston attachment can be axially screwed to one another. To be able to variably fix the position of the cylinder piston and of the cylinder piston attachment to one another in an axial direction, a counter nut can be provided against which the cylinder piston attachment can, for example, be screwed onto the cylinder piston.

The cylinder piston is preferably a pneumatic cylinder piston. This has the advantage that e.g. a pneumatic system already present for the supply of the processing element can be used to operate the cylinder.

In accordance with a further embodiment, the force application apparatus has a force transmission element that is movable relative to the cylinder piston and that is connected between the cylinder piston and the braking element. The preload force is then transmitted from the cylinder piston via the force transmission element to the braking element. The first spring element can be arranged between the force transmission element and the cylinder piston. The first spring element can in particular be arranged between two oppositely disposed end faces of the transmission element and of the cylinder piston. Thus, on the sliding along at the run-on surface, the processing element can push open the braking element in the direction of the opening position, whereby the braking element pushes the force transmission element against the restoring force of the first spring element into an opening position. Since the force transmission element is arranged in a movable manner with respect to the cylinder piston, the cylinder piston, in contrast, substantially does not move when the braking element is pushed from the braking position into the opening position. A movement of the piston is thus not necessary so that the head of the processing element can engage into the latch recess.

The force transmission element can be arranged in an axial opening of the cylinder piston attachment. The axial opening of the cylinder piston attachment preferably has two different widths, in particular diameters. The force transmission element can have two widths, in particular diameters, that correspond to the different widths of the axial opening. The first spring element can apply a force to the force transmission element at its wider end face and can push it along the axial opening against a coupling element of the braking element.

In accordance with an even further embodiment, a processing element drive device is provided that is configured to further transport the processing element in a conveying direction, in particular by means of compressed air, after a release by the braking element. The processing element drive device is preferably connected via a control module to the force application apparatus and is controlled such that the necessary drive power for the further transport of the processing element is already applied to the processing element at the point in time at which the processing element is released by the braking element.

The processing element drive device advantageously comprises at least one pneumatic line section that opens laterally into the guide channel in front of the braking element viewed in the transport direction of the processing element. The processing element can thus be transported further in a simple manner by means of compressed air.

The processing element drive device can have a plurality of pneumatic line sections that open laterally into the guide channel in front of the braking element viewed in the transport direction of the processing element.

At least one pneumatic line section, in particular all of the pneumatic line sections, can open into the guide channel at an angle of between 10° and 80° to the main direction of extent of the guide channel. The angle can in particular be between 20° and 70° and specifically between 30° and 60°.

The guide channel or the supply hose can have at least one compensation opening that provides a fluid connection between the guide channel and the environment. The compensation opening prevents a vacuum from arising in the guide channel or in the supply hose.

The invention will be described with reference to purely exemplary embodiments with reference to the enclosed drawings in the following. There are shown:

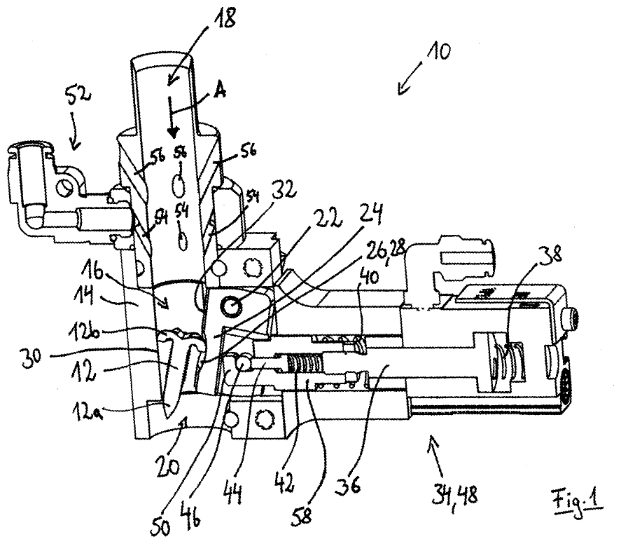

FIG. 1 a sectional view of an apparatus in accordance with the invention in a braking position;

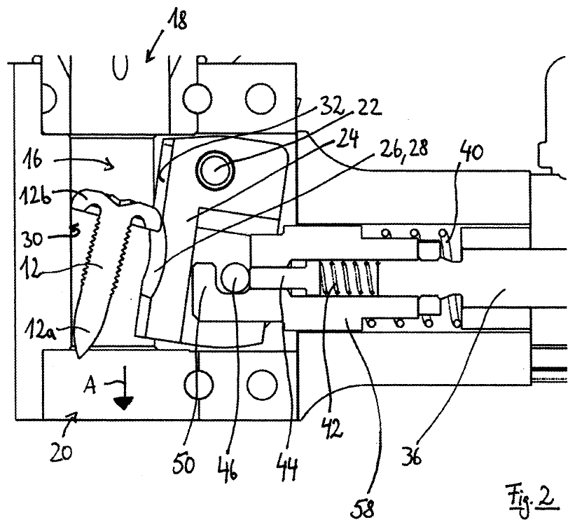

FIG. 2 a detailed view of the apparatus of FIG. 1 in an opening position; and

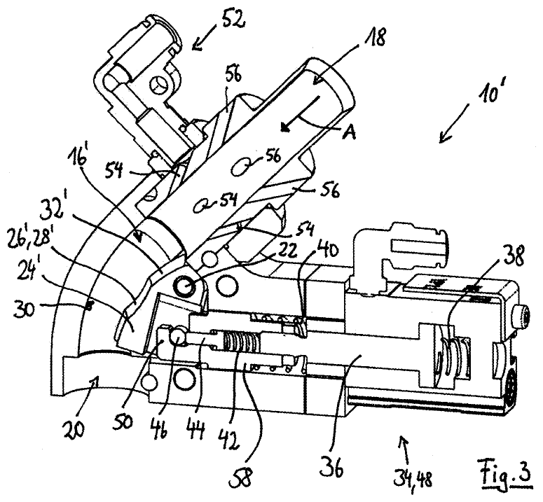

FIG. 3 a sectional view of a second apparatus in accordance with the invention with a curved guide channel.

The apparatus 10, 10′ shown in the Figures are provided to brake and to securely fix a processing element 12, in the present embodiments an FDS screw, that is supplied to a tool, likewise not shown, by means of a supply system, not shown, in the present embodiments a supply system operated by means of compressed air, until said processing element 12 can be released for a further transport to the tool. The tool is typically a bit of an automatic screwdriver.

The apparatus 10, 10′ comprises a housing 14 in which a guide channel 16 is formed. The guide channel 16 connects an input 18 and an output 20 of the apparatus to one another. The input 18 is couplable to a section of a hose-like or tubular line of the supply system that supplies the processing element 10. The output 20 is couplable to a section of a hose-like or tubular line of the supply system that transports away a processing element 10.

The apparatus 10, 10′ further comprises a braking element 24 that is pivotably supported about a pivot axis 22 and that can be partly introduced into the guide channel 16 to brake and hold the supplied processing element 12 in a predefined section of the guide channel 16. The pivot axis 22 of the braking element 24 is located in front of a latch recess 28 in a transport direction A of the processing element.

FIG. 1 shows the braking element 24 in its braking position. In this braking position, the braking element 24 partly projects into the guide channel 16 and narrows the guide channel 16 in such a manner that the processing element 12 cannot completely pass the braking element 24. In other words, the braking element 24 blocks the guide channel 16 between the input 18 and the output 20 for the processing element 12. The part of the braking element 24 that projects into the guide channel 16 and thereby narrows the guide channel 16 has an end face 26 that faces the guide channel 16 and that is in particular adapted to the shape or extent of the guide channel 16. The end face 26 forms the latch recess 28 for holding a head 12b of the processing element 12. The processing element 12 is therefore held in the latch recess 28 by a form fit between the head 12b of the processing element 12 and the latch recess 28. In addition, the braking element 24 can press the head 12b of the processing element 12 against an inner wall 30 of the guide channel 16 so that the processing element 12 is clamped between the braking element 24 and the inner wall 30 of the guide channel 16.

The braking element 24 furthermore has, at the end face 26, a run-on surface 32 arranged upstream of the latch recess 28 in a transport direction A of the processing element 12. In the braking position of the braking element 24 shown in FIG. 1, the run-on surface 32 projects into the guide channel 16 at an angle to the inner wall 30 of the guide channel 16 so that a passage section defined by the inner wall 30 of the guide channel 16 and by the run-on surface 32 is continuously narrowed along the run-on surface 32.

The apparatus 10 further comprises a preloading device 34 that acts against a movement of the braking element 24 from the braking position into the release position and that preloads the braking element 24 into the braking position. For this purpose, the preloading device 34 has a cylinder piston 36 having a cylinder piston attachment 58 that is pushed into an extended position corresponding to the braking position of the braking element 24 by means of two spring elements 38, 40 connected in parallel. In this position, the cylinder piston 36 transmits the preloading force of the spring elements 38, 40 via a further spring element 42 to a force transmission element 44. This force transmission element 44 transmits the preloading force to a coupling element 46 of the braking element 24.

Instead of two spring elements 38, 40 connected in parallel, only a single spring element can also be provided. In principle, it would also be conceivable to provide more than two spring elements for preloading the cylinder piston 36.

The cylinder piston 36 is simultaneously a part of a force application apparatus 48 that is configured to adjust the braking element 24 from the braking position into the release position. In the present example, the cylinder piston 36 is designed as a pneumatic cylinder piston. An actuating force can be applied by means of compressed air to the cylinder piston 36 and the cylinder piston 36 is moved by said actuating force against the restoring force of the spring elements 38, 40, to the right in the Figures, in order to adjust the braking element 24 into the release position. To apply the actuating force to the braking element 24, a hook-shaped section 50 which engages around the coupling element 46 of the braking element 24 is provided at the end of the cylinder piston 36 or of the cylinder piston attachment 58 facing the braking element 24. The hook-shaped section 50 surrounds the coupling element 46 at three sides, wherein a clearance is provided between the oppositely disposed sides and the coupling element 46. The coupling element 46 is configured as a pin and has a rounded run-on surface that is or comes into contact with the hook-shaped section 50 when the cylinder piston 36 pulls the braking element 24 from the braking position into the release position.

The cylinder piston 36 is consequently configured such that it pushes the braking element 24 into the braking position as long as no pneumatic force is applied to the cylinder piston. As soon as the braking element 24 is to be pivoted into the release position and a pneumatic force is therefore applied to the cylinder piston 36 and urges the cylinder piston 36 away from the guide channel 16, the cylinder piston, in contrast, pulls the braking element 24 into the release position.

The apparatus 10 additionally comprises a processing element drive device 52 that is configured to further transport the processing element 12 in a transport direction A by means of compressed air after a release by the braking element 24. The processing element drive device 52 has at least one pneumatic line section 54 that opens laterally into the guide channel 16 in front of the braking element 24. As can be seen in FIG. 1, the pneumatic line section 54 opens into the guide channel 16 at an angle of approximately 40° to the main axis of the guide channel 16 or to the transport direction A of the processing element 12. As can likewise be seen in FIG. 1, a plurality of pneumatic line sections 54 distributed along the periphery can be provided to exert a stronger and more uniform drive force onto the processing element 12. In addition, compensation openings 56 can also be provided that are arranged offset from the pneumatic line sections 54 along the main axis of the guide channel 16. The compensation openings 56 establish a fluid connection between the supply hose or the guide channel 16 and an environment. This fluid connection to the environment ensures that environmental air can penetrate into the supply hose or the guide channel 16. A vacuum is hereby prevented from arising in the supply hose or in the guide channel 16.

It will now be explained in the following how the apparatus 10 gently brakes the processing element 12, holds it securely and releases it again in a precise manner.

If a processing element 12 is transported through the input 18 up to the braking element 24, the tip 12a of the processing element 12 passes the run-on surface 32 of the braking element 24 without moving the braking element 24 out of its braking position since the braking element 24 does not narrow the guide channel 16 in such a manner that the tip 12a would no longer fit through the narrowed guide channel 16. However, as soon as the head 12b of the processing element 12 slides into the section of the guide channel 16 which is narrowed by the run-on surface 32 when the braking element 24 is in the braking position, the head 12b of the processing element 12 comes into contact with the run-on surface 32 since the run-on surface 32 narrows the guide channel 16 in such a manner that the head 12b of the processing element 12 does not fit through. On the sliding along at the run-on surface 32, the processing element 12 pushes away the braking element 24 away so that the latter is pivoted from the braking position shown in FIG. 1 into the opening position shown in FIG. 2. The force applied by the processing element 12 to the braking element 24 ensures that the first spring element 42 is compressed in that the coupling element 46 of the braking element 24 presses against the force transmission element 44. The force transmission element 44 then in turn presses against the first spring element 42, whereby the latter is compressed. The restoring force or the spring constant of the first spring element 42 is adapted such that a movement of the braking element 24 in the direction of the release position up to an opening position can be brought about by an impact and a sliding along of the head 12b of the processing element 12 at the run-on surface 32.

In contrast, the cylinder piston 36 does not move when the braking element 24 is moved from the braking position into the opening position since the second spring elements 38, 40 as a spring arrangement together have a higher spring stiffness than the first spring element 42.

As soon as the head 12b of the processing element 12 has reached the end of the run-on surface 32, see FIG. 2, the head 12b latches into the latch recess 28. The opening force transmitted from the head 12b to the braking element 24 hereby decreases and the braking element 24 can pivot back into the braking position. The first spring element 42 can hereby at least partly expand again. The head 12b of the processing element 12, and thus the processing element 12, is now held in a form-fitted manner by the braking element 24, i.e. the head 12b partly engages into the latch recess 28. Since the latch recess 28 prevents a movement of the head 12b of the processing element 12 in both directions of the guide channel 16, the processing element 12 cannot be unintentionally released either in the direction of the output 20 or in the direction of the input 18. Thus, the processing element 12 is fixed in the region of the latch recess 28 by the braking element 24 even if the processing element 12 is accelerated in the direction of the input 18 by gravity or by a centrifugal force acting on the processing element 12, for example, when working overhead.

The force application apparatus 48 serves to release the fixing of the processing element 12 again. For this purpose, the cylinder piston 36 of the force application apparatus 48 is moved by means of compressed air against the restoring force of the spring elements 38, 40 from the position corresponding to the braking position of the braking element 24 into a position corresponding to the release position of the braking element 24. In this respect, the hook-shaped section 50 of the cylinder piston 36 pulls at the coupling element 46 and thus pulls the braking element 24 from the braking position into the release position, not shown, in which the braking element releases the guide channel 16. If the guide channel 16 is released, the processing element 12 together with the head 12b can pass the braking element and can move to the output 20 of the guide channel 16.

To ensure a further transport, in particular also when working overhead, a pneumatic drive force is provided by the processing element drive device 52 on the release of the braking element 24. For this purpose, compressed air is introduced through the pneumatic line sections 54 and ensures that the processing element 12 is always transported further in the direction of the output 20 independently of the position of the apparatus in a space and thus independently of the direction of action of gravity.

FIG. 3 shows a further embodiment of the invention. In contrast to the embodiment shown in FIG. 1 and FIG. 2, a curved guide channel 16′ is provided instead of a straight guide channel 16. The end face 26′ of the braking element 24′ is adapted to the curved shape of the guide channel 16′ so that the diameter of the guide channel 16′ remains substantially constant along the direction of movement A of the processing element when the braking element is in the release position. Such a curvature of the guide channel 16′ and of the end face 26′ of the braking element 24′ can have 45° or 90°, for example.

In the present embodiment, the apparatus is used to brake, to fix, and to release FDS screws, i.e. flow-drilling screws. However, the apparatus can naturally also be used for any other processing elements that have a head, i.e. a lateral projection, and that are thus suitable for entering into a form fit with the latch recess.

### REFERENCE NUMERAL LIST

10 apparatus
12 processing element
12A tip
12B head
14 housing
16 guide channel
18 input
20 output
22 pivot axis
24 braking element
26 end face
28 latch recess
30 inner wall
32 run-on surface
34 preloading device
36 cylinder piston
38 spring element
40 second spring element
42 first spring element
44 force transmission element
46 coupling element
48 force application apparatus
50 hook-shaped section
52 processing element drive device
54 pneumatic line section
56 compensation opening
58 cylinder piston attachment
A transport direction of the processing element

1.-15. (canceled)

16. An apparatus for braking and holding a processing element, the processing element having a head and being automatically supplied to a tool, said apparatus comprising a guide channel for the processing element; and a braking element that is movably supported between a braking position and a release position and that can be at least partly introduced into the guide channel to brake and hold the processing element supplied, wherein a part of the braking element that projects into the guide channel in the braking position and thereby narrows the guide channel has an end face that faces the guide channel and that forms a latch recess for holding the head of the processing element.

17. The apparatus in accordance with claim 16, wherein the apparatus is configured such that it brakes the processing element solely at the head.

18. The apparatus in accordance with claim 16, wherein the braking element is configured and arranged such that it applies a clamping force directed transversely to a main direction of extent of the guide channel to the head of a held processing element in the braking position.

19. The apparatus in accordance with claim 16, wherein a preloading device is provided that preloads the braking element against a movement into the release position.

20. The apparatus in accordance with claim 19, wherein the braking element has a run-on surface which is arranged upstream of the latch recess in a transport direction of the processing element and by which the guide channel is narrowed when the braking element is in the braking position, with the preload force acting on the braking element being dimensioned such that a movement of the braking element in the direction of the release position up to an opening position can be brought about by an impact and a sliding along of the head of the processing element at the run-on surface.

21. The apparatus in accordance with claim 19, wherein the preloading device is configured such that a first force is required to move the braking element from the braking position in the direction of the release position up to an opening position and such that a larger second force is required to move the braking element from the opening position further into the release position.

22. The apparatus in accordance with claim 19, wherein the preloading device has at least two spring elements connected in series, with a movement of the braking element from the braking position into the opening position taking place against a first restoring force of a first spring element or of a first spring arrangement and a movement of the braking element from the opening position into the release position taking place against a second restoring force of a second spring element or of a second spring arrangement, and with the second restoring force being larger than the first restoring force.

23. The apparatus in accordance with claim 16, wherein the braking element is pivotably arranged at a housing.

24. The apparatus in accordance with claim 23, wherein the pivot axis of the braking element is arranged in front of the latch recess viewed in a transport direction of the processing element.

25. The apparatus in accordance with claim 16, wherein a force application apparatus is provided that is configured to adjust the braking element from the braking position into the release position.

26. The apparatus in accordance with claim 25, wherein the force for adjusting the braking element is generated by means of compressed air.

27. The apparatus in accordance with claim 25, wherein the force application apparatus comprises a cylinder pistonvia which the restoring force of at least one spring element can be transmitted to the braking element.

28. The apparatus in accordance with claim 25, wherein the cylinder piston is a pneumatic cylinder piston.

29. The apparatus in accordance with claim 27, wherein a force transmission element movable relative to the cylinder piston is provided, said force transmission element being connected between the cylinder piston and the braking element and being acted on by a restoring force of a first spring element, with the first spring element being supported at the cylinder piston.

30. The apparatus in accordance with claim 16, wherein a processing element drive device is provided that is configured to further transport the processing element in a conveying direction after a release by the braking element.

31. The apparatus in accordance with claim 30, wherein the processing element drive device is configured to further transport the processing element in the conveying direction by means of compressed air.

32. The apparatus in accordance with claim 30, wherein the processing element drive device comprises at least one pneumatic line section that opens laterally into the guide channel in front of the braking element in the main direction of extent of the guide channel.

33. The apparatus in accordance with claim 30, wherein the processing element drive device comprises a plurality of pneumatic line sections, that open laterally into the guide channel in front of the braking element in the main direction of extent of the guide channel.

34. Method of using an apparatus for braking and holding a processing element, the processing element having a head and being automatically supplied to a tool, said apparatus comprising a guide channel for the processing element; and a braking element that is movably supported between a braking position and a release position and that can be at least partly introduced into the guide channel to brake and hold the processing element supplied, wherein a part of the braking element that projects into the guide channel in the braking position and thereby narrows the guide channel has an end face that faces the guide channel and that forms a latch recess for holding the head of the processing element, wherein the apparatus is used to brake, fix and release a screw.

35. The method in accordance with claim 34, wherein the screw is an FDS screw.

36. The method in accordance with claim 34, wherein a braking of the screw is brought about by a braking force transmission from the apparatus solely to the head of the screw.
